(19) United States
(12) Patent Application Publication
(10) Pub. No.: US 2018/0095439 A1
(43) Pub. Date: Apr. 5, 2018

(54) UNIVERSAL DEVICE COMMUNICATION AND CONFIGURATION

(71) Applicants: Rouzbeh Karbasian, Kirkland, WA (US); Amir Karbasian, Kirkland, WA (US)

(72) Inventors: Rouzbeh Karbasian, Kirkland, WA (US); Amir Karbasian, Kirkland, WA (US)

(21) Appl. No.: 15/284,417

(22) Filed: Oct. 3, 2016

(51) Int. Cl. G05B 19/042

(52) U.S. Cl. CPC G05B 19/0426; G05B 2219/25085

(57) ABSTRACT

A method and a device are disclosed including a computer network coupling multiple network ordinary devices and master devices communicating via a middle layer communication software that is device-independent. The master devices are programmable via a Universal Programming Application (UPA) that is installed on the devices. Devices include sensors or home or industrial accessories, smart TV, smart Refrigerator, smart oven, smart coffee makers, industrial or non-industrial machine or component, a software application, and generally any other device that is capable of connecting to a network to exchange data. A device may include events and services. Events are distinct changes in status or configuration of a device. Services are functions a device may perform. In some embodiments, the set of events and services defined for a device may be available via a catalog service. Events and services may be local to the master device or be remote.

### TECHNICAL FIELD

This application relates generally to device configuration. More specifically, this application relates to a system of universal networked device communication and configuration.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example network connected device environment usable with devices of FIGS. 1 and 2;

FIG. 4 shows an example schematic ordinary and master device communication and configuration network environment;

FIG. 5A shows an example configurable device with network connection usable in the network environments of FIGS. 3 and 4;

FIG. 5B shows an example event structure embedded in device of FIG. 5A;

FIG. 5C shows an example service structure embedded in device of FIG. 5A;

FIG. 6 shows an example configurable master device with memory, processor, and network connection usable in the network environments of FIGS. 3 and 4;

FIG. 7 shows an example workflow-based event handlers usable with devices of FIG. 4;

FIG. 8A shows an example Universal Programming Application (UPA) login user interface usable to program multiple devices in the communication environments of FIGS. 3 and 4;

FIG. 8B shows an example software structure of the Universal Programming Application (UPA) of FIG. 8A;

FIG. 9 shows an example UPA start page for finding devices in communication environments of FIGS. 3 and 4 and selecting programming types;

FIG. 10 shows an example UPA master device selection user interface;

FIG. 11 shows an example UPA event handler management user interface;

FIG. 12 shows an example UPA workflow definition and management user interface;

FIG. 13 shows an example UPA event handler addition and definition user interface;

FIG. 14 shows an example UPA device event selection and parameter identification and management user interface;

FIG. 15 shows an example UPA new event handler definition based on events of a particular selected device;

FIG. 16 shows an example UPA conditional expression definition and management user interface;

FIG. 17 shows an example UPA logical expression definition user interface;

FIG. 18 shows an example UPA relational expression definition user interfaced;

FIG. 19 shows an example UPA static value type selection user interface;

FIG. 20 shows an example UPA parameter-based value type selection user interface;

FIG. 21 shows an example UPA service-based value type selection user interface;

FIG. 22 shows an example UPA event parameter-based relational expression definition user interface;

FIG. 23 shows an example UPA action definition user interface;

FIG. 24 shows an example UPA service-based action definition user interface; and

FIG. 25 shows an example UPA programming conclusion confirmation user interface.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references particular devices like limited embedded device and master device, it will be appreciated that the disclosure may be used with other types of high level systems such as computers, cloud computing, applications, and the like.

Briefly described, a device and a method are disclosed including a computer network coupling multiple network ordinary devices and master devices communicating via a middle layer software that is device-independent. In some embodiments, the master devices are programmable by a user via a Universal Programming Application (UPA) or app, that is installed on the devices. Ordinary devices include sensors or home or industrial accessories, smart TV, smart Refrigerator, smart oven, smart coffee makers, industrial or non-industrial machine or component, a software application, and generally any other device that is capable of connecting to a network to exchange data. A device may include events and services. Events are distinct changes in status or configuration of a device and may include receipt or change of data, alarms, powering down or up, and the like, that may be multicast on the network or be reported to another device, or a master device on command or periodically. Services are functions a device may perform, such as measurement of a parameter, or performance of a calculation, reporting of data, or other functions that may be requested by a master device or other network devices. In some embodiments, the set of events and services defined for a device may be available via a catalog service. A master device may listen for various events on the network and take appropriate action according to its own stored program. Events are outputs only from devices, while services may return a value to the issuing device. Events and services may be local to the master device or be remote from other devices across the network. A user may query a list of devices via a master device through the UPA interface.

With the ubiquity of users' internet access there is an ever increasing demand for expanded services, functionality, online storage, sharing capabilities, and the like. In addition to web-based services offered to human users, the Internet Of Things (IOT) has been gaining in commercial popularity to reduce cost and increase functionality in an efficient, automated manner. Many simple devices and systems, such as refrigerators, television sets, premises alarm systems, thermostats, garage door openers, video cameras, lights, sprinkler systems, heating and cooling systems, various factory machinery, and the like may be controlled remotely and automatically by using IOT or other network-based data communications. Each of the many devices connected to a computer network such as the Internet, have to be configured, programmed, set up, or otherwise be prepared to communicate with other devices, report events, and perform services. The configuration of such devices and updating the configuration as needed is a challenge, especially given the myriad manufacturers, technologies, models, functionalities, and other variables, which affect how these devices are configured or programmed. A uniform method of configuring or programming network-connected devices may be a significant advantage.

### Illustrative Operating Environment

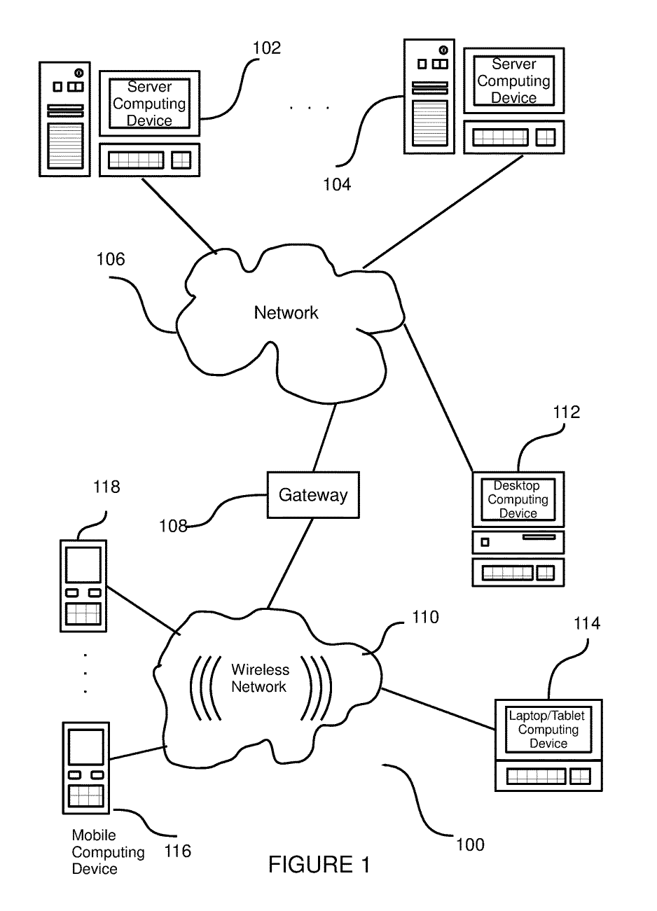

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

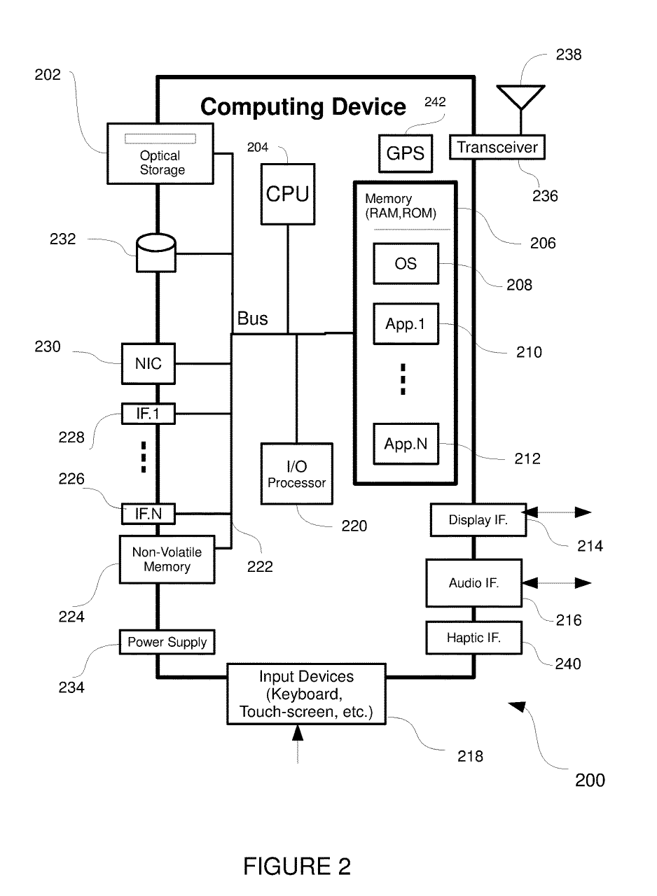

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, Bluetooth Low Energy (LE), High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 230, hard disk 232, power supply 234, transceiver 236, antenna 238, haptic interface 240, and Global Positioning System (GPS) unit 242. Memory module 206 may include software such as Operating System (OS) 208, and a variety of software application programs and/or software modules/components 210-212. Such software modules and components may be stand-alone application software or be components, such as DLL (Dynamic Link Library) of a bigger application software. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general- purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC (Media Access Control) address.

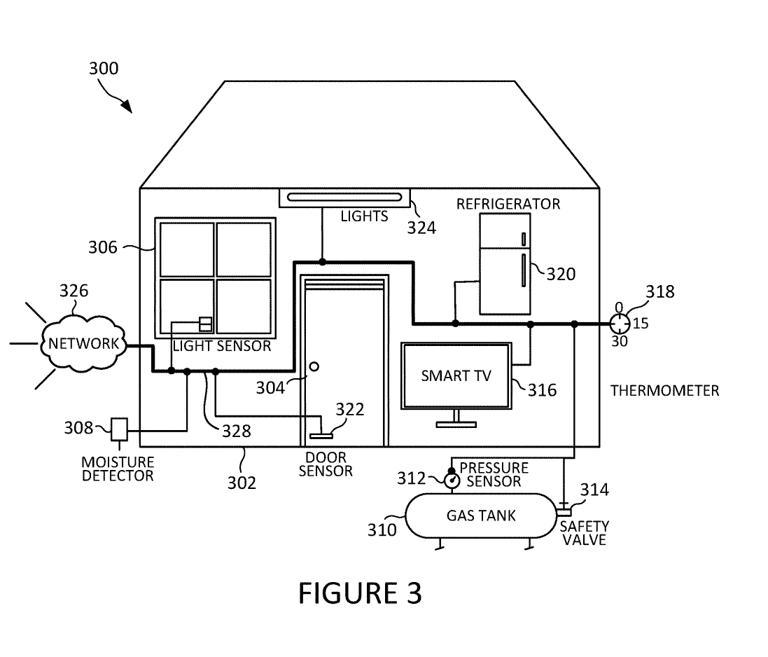

FIG. 3 shows an example network connected device environment usable with devices of FIGS. 1 and 2. In various embodiments, network environment 300 may house different network-connected devices within a building 302 and include door 304, window 306, moisture detector 308, gas tank 310, pressure gauge 312, safety valve 314, smart TV 316, thermometer 418, refrigerator 320, door sensor 322, lights 324, light sensor, network 326, and network connection 328 for coupling all devices to the network.

In various embodiments, all network-capable devices are coupled to the network 326 via a wired or wireless connection. Each device may include various pre-defined events and services that may be used by other devices. For example, the pressure sensor 312 on gas tank 310 may include an event that defines a low-pressure or low-gas condition indicating that the gas tank may need to be refilled. Another example, is an event that defines a low-light threshold by the light sensor. Each device may further offer some services that are predefined for use by other devices. For example, lights 324 may offer a service of turning ON or OFF. In this example, if the light sensor indicates, via an event, that the ambient light is too low, then lights 324 may be turned ON to illuminate the space around it. Another example, is that the smart TV 316 may offer recording services may be activated remotely to record a favorite show.

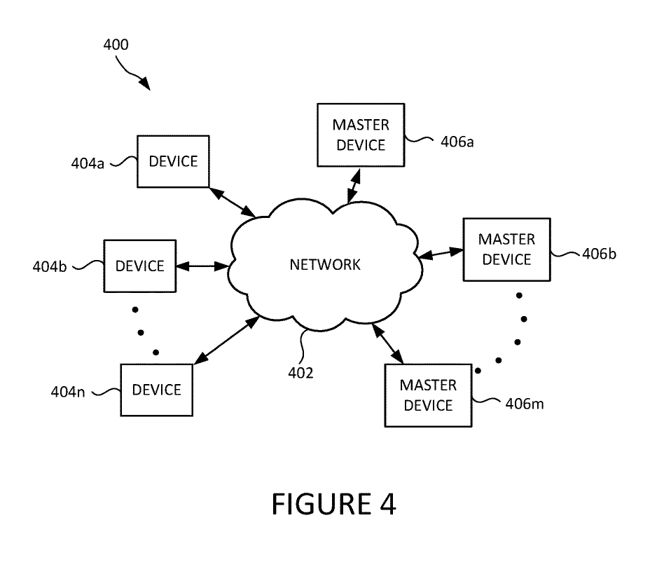

As further described below with respect to FIGS. 4-6 and other figures, the network environment 300 may include two general types of devices: ordinary devices and master devices. Briefly, the ordinary devices are more limited in terms of programming and functionality. Master devices, may be programmed via a Universal Programming Application (UPA) by a user to perform various tasks in response to a detected event, a predefined time, periodically, or otherwise. Ordinary devices may be considered as remote with respect to a master device since the master device generally communicates with ordinary devices via a computer network. Both ordinary and master devices may have their own events and services, which may be accessible to users or other devices. The events and services of master devices may be considered local with respect to the master device itself.

FIG. 4 shows an example schematic ordinary and master device communication and configuration network environment. In various embodiments, communication environment 400 includes a computer network 402, ordinary devices 404a, 404b, and 404n, and master devices 406a, 406b, and 406m.

In various embodiments, the computer network 402 may be the internet, a local network, a wide area network, a network based on wired or wireless or combination of both that is based on any operable protocol, such publicly used protocols like TCP/IP or proprietary protocols. Those skilled in the art will appreciate that a computer network may be complex and include several subnets, gateways, various protocols, and the like. Any computer network, private or public, that can deliver data and be used for data communications may be used with the ordinary and master devices.

In various embodiments, the ordinary devices may be subordinate devices designed to handle specific and limited tasks with minimal configuration. The ordinary devices may include refrigerators, TV sets, pressure sensors, moisture sensors, light sensors, lights and lighting systems, valves, door and window locks, thermostats, water level sensors, alarm and security systems, video and camera systems, sound systems, electrical power switches, appliances like coffee makers and dishwashers, basic and dedicated communication systems like routers and transceivers, various actuators for performing simple mechanical tasks like releasing a lock or closing shutters, industrial equipment and machines that can turn ON or OFF and perform various appropriate tasks such as material mixers and conveyor belts, and the like.

Each such ordinary device may include one or more events and services. An event is a change of some predefined parameter or state of a system. For example, the dimming of light below a preset threshold may be considered or be defined as an event. The opening or closing of a door may also be considered an event. The events are generally output from a device. A device does not receive an event. Such reporting may be automatic and immediate as soon as the event is detected or occurs, it may be periodic, it may be on a predefined schedule like every hour or every week, it may be on command or query from a master device, or based on any other criteria. Services may be also be provided by ordinary devices.

Services are predefined tasks or information that are generally performed/produced and/or transmitted by the device on request or command. In some embodiments, services may be launched automatically in response to an event or values returned from other services. For example, a command may be issued by a master device to a light controller device to perform a service that turns ON a light and returns a confirmation. If the confirmation value indicates that the light did not turn ON, then the master device may issue an alarm to a user to investigate and/or change the light bulb. Services may or may not return one or more values, like a mathematical function. The returned values may be parameters that provide some information to the device that invoked the service. For example, one form of value may be an acknowledgement or confirmation of an action that the service performed. Another form of returned value may be a set of values that indicate the status or state of a system, such as the state of each light that was turned ON or OFF because of the service performed to control a series of lights. Those skilled in the art will appreciate that the returned values may be any quantity that serves to provide some information to the user of the service.

In various embodiments, each ordinary device and master device may be uniquely identified by a GUID (Globally Unique ID). Those skilled in the art will appreciate that GUIDs may be generated by software based on unique events and quantities such as a combination of a timestamp and other quantities like a serial number or MAC (Media Access Control) number assigned to the device at manufacture time. Because a date-time stamp, including seconds and smaller units never repeats, it is guaranteed to be unique, particularly in combination with other identifiers. Some GUIDs may also be generated based on random number generators.

In addition to the devices, in some embodiments, each event and service may also be associated with a GUID of its own. In some embodiments, the GUIDs associated with the events and services may be based on the GUID of the device to which the event or the service belongs. In other embodiments, the event and service GUIDs may be assigned independently from the device GUIDs. Some service and/or events may be shared by several devices. For example, a command to power up or shut down issued to a device may be universal as it may be applicable many or all devices that may receive such commands. Some events and services may also be specific to a particular device that performs a specific and unique function, such as a defrost command to a refrigerator, which is not applicable to a toaster or a coffeemaker.

In addition to the GUID, as IOT or network devices, the ordinary devise and master devices may also be assigned a network identifier to allow unambiguous communication on a subnet. Such network identifiers may be IP addresses or other customary network identifiers that may be used to address a recipient for data transmission across the network.

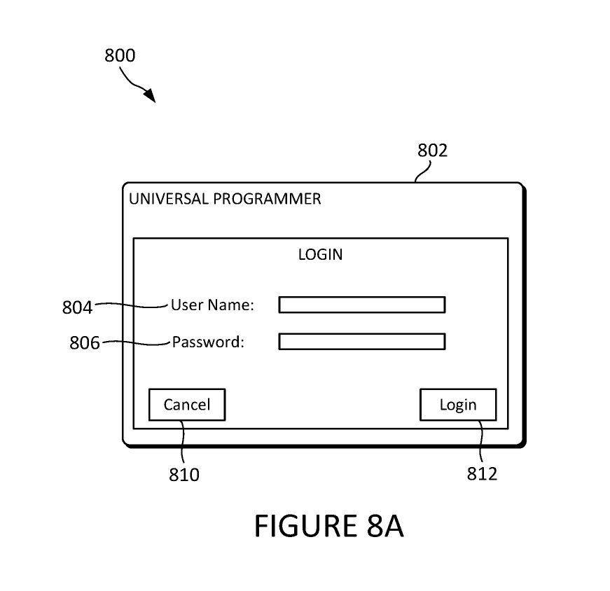

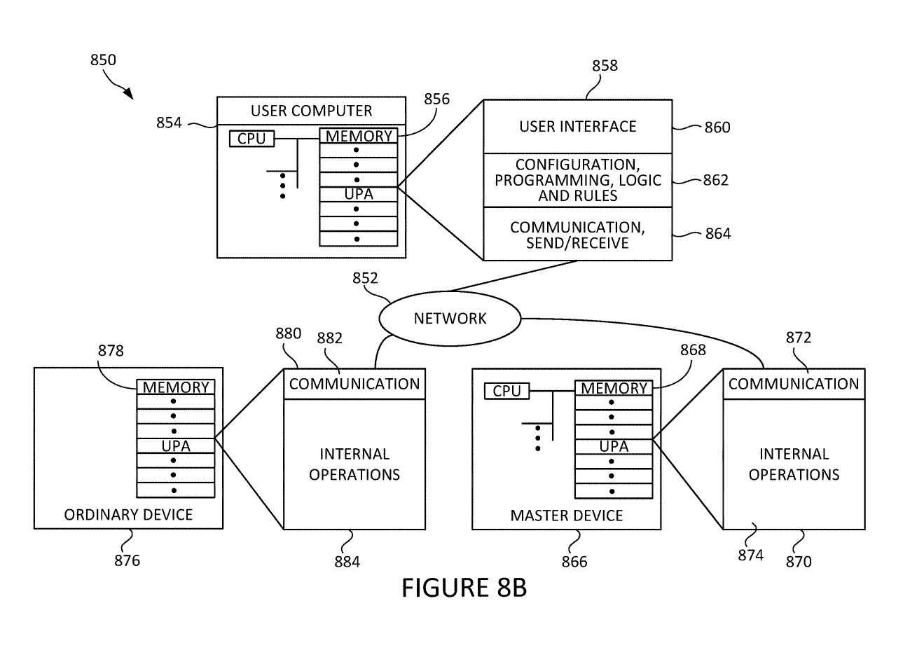

In various embodiments, a master device 406a-m may be programmed and/or configured via the UPA (Universal Programming Application). The software structure of the UPA may be layered to preclude the need for software device drivers to allow communication with the many devices involved. This structure is further described below with respect to FIG. 8B.

In various embodiments, in operation, one or master devices may be accessed via its network ID and programmed by a user via UPA interface to manage other ordinary devices or even other master devices. The user may login, via a user computer or mobile device, to a master device over the network via the UPA user interface to program the master device and also to configure other ordinary devices on the network via the master device. In some embodiments, the UPA may be a browser-based interface that uses the known protocols and standards in web browsing such as HTTP, HTML, HDML, SOAP, XML, and the like. In such an interface the user may be presented with hotlinks, buttons, menus, data input fields for entering programming scripts, or high-level menus for selecting and combining statements and expressions for defining rules to be executed by the programmed device, and the like to configure the master device and/or the ordinary devices. The UPA interface and general programming methods are further discussed below in more detail with respect to FIGS. 8-24. The user may also use the same interface to access results or status of services and events for various devices on the network. In other embodiments, the UPA may be a custom application, different from a browser, designed for communication with the master devices. Those skilled in the art will appreciate that the UPA may have a GUI (Graphical User Interface), a command line interface in which commands are entered at a prompt by the user to perform various programming tasks. In still other embodiments, the UPA may include an editing interface using which the user can write programs (compiled or translated into machine language) or scripts (system commands that are not compiled) that may be used to program the devices. In some embodiments, the user-created programs or operating rules may be downloaded onto the master device as a resident program to run locally on the master device independent on any connection to the user's computer or other devices.

In various embodiments, the master device may be programmed by the user to control/manage other master or ordinary devices like a central controller. In other embodiments, several master devices may control the system in parallel and/or in collaboration with each other. For example, to control facilities in a building, a user computer may be connected to a master device in the building and download a program to the master device, which defines what tasks the master device performs under defined conditions and how to control and/or configure other master or ordinary devices. In this example, the master device may be programmed to monitor temperature and doors and windows in a building. The master device, based on its program, may configure an ordinary device, such as a thermometer to report when a temperature threshold is exceeded, and configure a proximity detector to report when a window is open. Based on these data, the master device may then command an air conditioner to turn itself ON and cool the space.

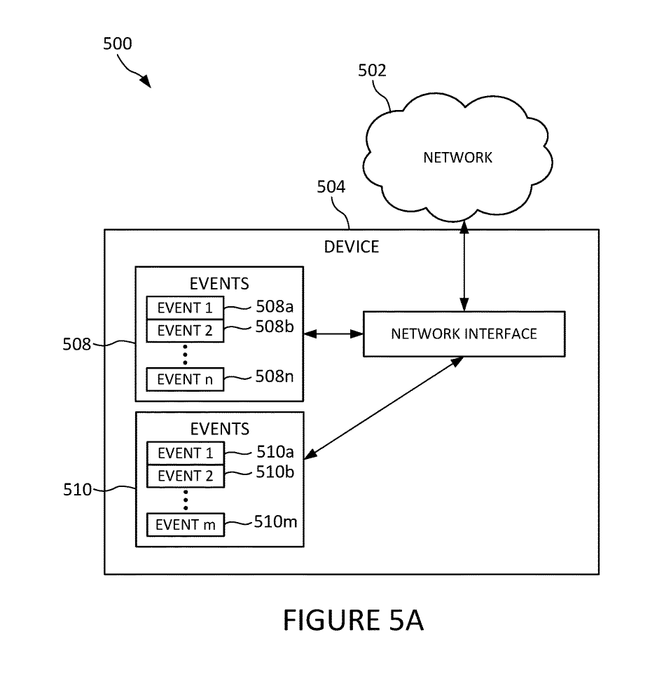

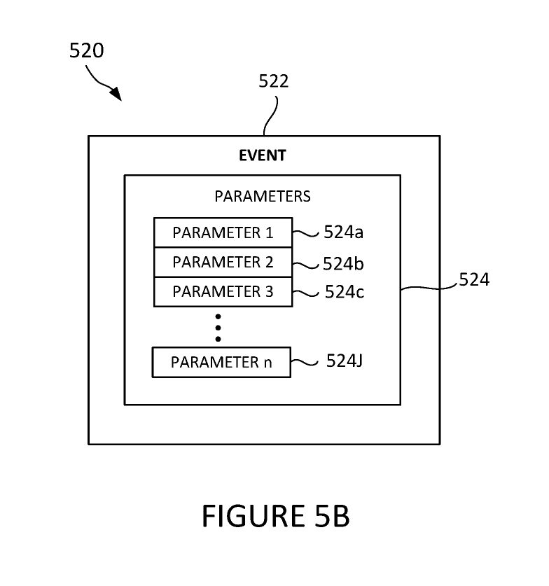

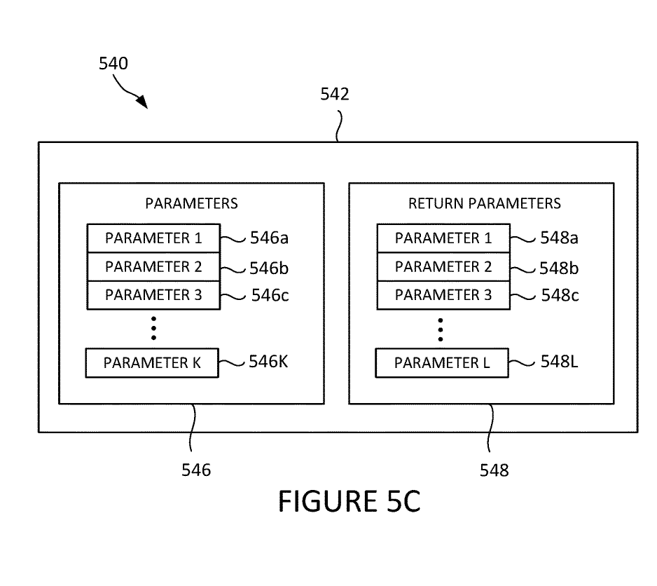

FIG. 5A shows an example configurable device with network connection usable in the network environments of FIGS. 3 and 4. In various embodiments, the device arrangement 500 includes network 502, ordinary device 504 having event list 508 including events 508a, 508b, through 508n, and services list 510 including services 510a, 510b, through 510m. The device may further include a network interface 506 for coupling the device with the network 502.

In various embodiments, the ordinary device may include a configuration or programming memory and a simple processor for executing basic commands (not shown in this figure), which may be predefined. Alternatively, the ordinary device may include hardware circuits to implement the command interface and communication protocols. In still another embodiment, the ordinary device may be designed to have both hardwired circuits and firmware/software to implement its functionality for processing commands and communicating data.

In various embodiments, the events and services may have other parameters for further defining the events and services, as described in more details below with respect to FIGS. 5B and 5C.

In various embodiments, the events are output methods in that they transmit data outwards from the device associated with the event to other devices, such master devices, that may consume or use the event information. In some embodiments, the events are also input channels in that some parameters may be supplied initially to configure or define what the event is or the conditions under which the event is reported by the device, as further described below with respect to FIG. 5B.

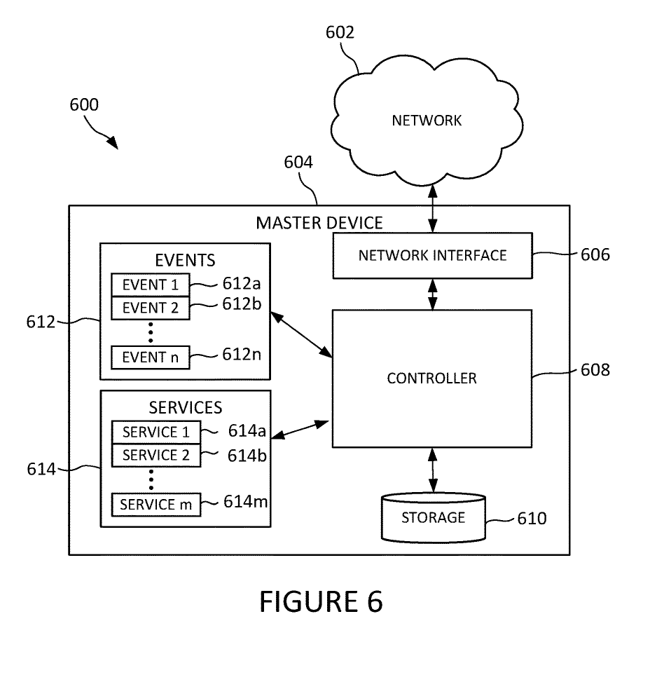

In various embodiments, the events and services may be cataloged to be discoverable by other devices that may use such events and services. Various network protocols may be used to discover the events and parameters published by the devices as they join the network, such as the use of Discovery packets. When a device joins a network or subnet, it may broadcast its events and services, which may be captured and stored by a master device listening on the subnet. Later, other devices may query these device capabilities by broadcasting a request or specifically querying a particular master device, which then responds by broadcasting the information or returning a specific response to a requester. In these embodiments, a network catalog, maintained by a database device, a master device, or other devices on the network, provides catalog services to discover device characteristics, events, and services. For example, a user may login to a network and query all devices that are UPA-compatible. The network catalog service may then return a list of all the available devices. The user may then select a subset of these devices to interact with or query further regarding their capabilities, events, services, and their respective parameters. Such events, services, and parameters are further described below with respect to FIGS. 5B through 6, and also some other figures throughout this specification.

FIG. 5B shows an example event structure embedded in device of FIG. 5A. In various embodiments, the event structure 520 includes an event 522 having a list of parameters 524, including parameters 524a, 524b, 524c, through 524j.

In various embodiments, the event parameters may provide additional information about the identification and selection of one event among many. For example, the event may be parametrized with an index number as Event(1), Event(2), and so on, to indicate which of a series of events is targeted. An event is a single signal, in the form an identifiable datum or quantity (for example, having an encoded value to distinguish it from other quantities or events), that indicates to a requester, master device, or user that something has occurred. The parameters of the event, if any, themselves being other pieces of data in a predefined format and/or data type (for example, text, integer, real number, an enumeration, and the like), are not values returned by the event, but rather, are used to define and/or identify what the event is and the applicable conditions for the triggering or expression of the event. The events may have more than one parameter to provide other information, such as time, sequence, device state or configuration, and the like. For example, many devices may include a Power On Self-Test (POST) for testing the health of the system during a power up period. So, an event such as “Event(3, POST)” may use two parameters to indicate a test result of a third test for the device during POST. In this example, the first parameter (3) may indicate which of several tests the event is associated with and the second parameter (POST) may indicate the conditions under which the event is applicable. The event parameters are generally provided and used by the requester or user of the events to identify an event and the conditions under which that event should be reported, in addition to which one of several event-handlers is to be used to take appropriate actions in response to the detection of the event.

FIG. 5C shows an example service structure embedded in device of FIG. 5A. In various embodiments, the service structure 540 includes a service 542, which in turn includes input parameter list 546 having input parameters 546a, 546b, 546c, through 546k, and return parameter list 548 having return parameters 548a, 548b, 548c, through 548L.

In various embodiments, the service input parameters 546a-546k may provide additional information about what information or data the service may have to acquire in response to being invoked by a user or a master device, and possible the identification of a particular service in a series of similar services, in manner similar to event identification described above. For example, the service may be parametrized with an index number as Temperature-Service(1), Temperature-Service(2), and so on, to indicate which of a series of services is being called for measuring temperature at different points in a system or device. The input parameters play a similar role to function parameters when calling a function in a programing language such as the C computer language. The service input parameters, if any, are pieces of data in a predefined format and/or data type (for example, text, integer, real number, an enumeration, and the like). The services may have more than one input parameter to provide other information, such as time, sequence, device state or configuration, and the like. The input parameters are supplied by the requester (for example, a user or a master device) at the time of calling or invoking the service. For example, many devices may include a system test for testing the health of the system. So, a service call such as “RunTest(2, SEND)” may use two parameters to indicate a request to run a service to test a data transmission function. In this example, the first parameter (2) may indicate which of several transmission units the service must test, and the second parameter (SEND) may indicate the particular test to run for sending data out. The input parameters are generally used by the requester or user of the service possibly to identify a service and mostly to specify the particular function to perform or data needed to perform a particular function by the service.

FIG. 6 shows an example configurable master device with memory, processor, and network connection usable in the network environments of FIGS. 3 and 4. In various embodiments, the device arrangement 600 includes network 602, master device 604 having network interface 606 for connecting with network 602, a processor or controller 608, and data storage 610. The master device may further include event list 612 of events 612a, 612b, through 612n, and service list 614 of services 614a, 614b, through 614m. The master device components mentioned above are generally interconnected in a star or bus or other connection configurations.

In various embodiments, the master device may be similar to or simpler than the computing device shown in FIG. 2, and include a configuration or programming memory or digital data storage and a software programmable CPU for executing stored programs, which may be downloaded to the master device's memory or storage before execution begins. In other embodiments, the master device may be designed to have both hardwired circuits and firmware/software to implement its functionality for executing programs and communicating data. In various embodiments, the controller 608 may include a complete basic computer on an integrated chip. For example, it may include a processor, memory, Input/Output (I/O) ports, and basic communications. Those skilled in the art will appreciate that the computing and communication components discussed above or others that may be included in the master device, may be integrated at any level and be on one or more modules without affecting the appropriate and corresponding functions.

In various embodiments and with continued reference to FIG. 6, the events and services mentioned above for the master device 604 are substantially similar to the events and services described above with respect to FIGS. 5B and 5C with regard to the ordinary device 504 (see FIG. 5A).

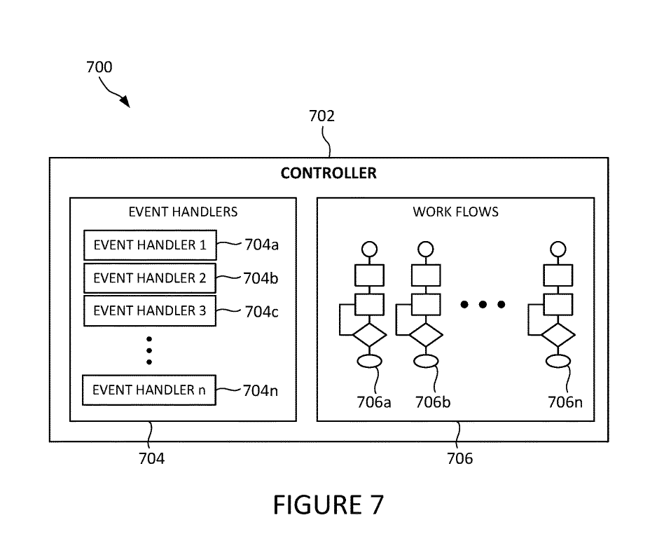

FIG. 7 shows an example workflow-based event handlers usable with devices of FIG. 4. In various embodiments, the controller configuration 700 may include controller 702 having an event handler list 704 including event handlers 704a, 704b, 704c, through 704n. The controller may further include a workflow list 706 including workflows 706a, 706b, 706c, through 706n.

In various embodiments, each event may correspond with usually one but sometimes more than one even handlers. Generally, when an even is triggered, signaled or otherwise occurs, the receiver of the event notification or signal, such as the master device or an event management software module responsible for receiving notification of the occurrence of the event, launches (or causes to be launched) a software routine usually known as an event handler to handle, respond to, or process the event. For example, if a Power-ON event is detected in an ordinary device, the event management software module on a master device may detect (or be notified of) the occurrence of the event and launch the appropriate event handler pre-associated with that particular event type to start a test or to record the event and timestamp it, or take any other appropriate and predefined action.

In various embodiments, the event handler for a particular event may be various predetermined actions or sequence of actions associated with the particular event. The event handler may launch a workflow (a predefined routine, usually having multiple actions or other routines, that is launched when the event occurs), a triggered action (a specific single action), a script (a non-complied system command program), or executing a program (compiled). The content and form (that is, workflow, script, etc.) of the actions that the even handler may take depend on the design and implementation of the device or system. In some embodiments, the event handler may be loaded from a file in response to the corresponding event and be changeable by the user. In other embodiments, the event handler may be in the form of embedded software/firmware placed in the device at manufacture time.

FIG. 8A shows an example Universal Programming Application (UPA) login user interface usable to program multiple devices in the communication environments of FIGS. 3 and 4. In various embodiments, a UPA login user interface 800 may include a login dialog window 802, login authentication information including username 804 and password 806, a Cancel button 810 and a Login button 812.

In various embodiments, the UPA login interface appears on the computer of the user via which the master device is programmed, or ordinary devices are listed and queried. In some embodiments, the UPA may include several different or similar modules deployed on various devices including the user's computer, each master device and each ordinary device. The architecture and operation of the UPA are further described with respect to FIG. 8B below.

FIG. 8B shows an example software structure of the Universal Programming Application (UPA) of FIG. 8A. In various embodiments, the UPA deployment arrangement 850 may include a computer network 852 coupled with a user computer 854 having a memory 856 embedding a UPA layered software structure 858 with separate software layers including UPA user interface 860, a programming and logic layer 862, and a communication layer 864 coupled with the network 852. The arrangement 850 may include a master device 866 having a memory 868 including a master device UPA module 870 with separate software layers including a communication layer 872 coupled with the network, and an internal operations module 874. The arrangement 850 may also include an ordinary device 876 having a memory 878 including an ordinary device UPA module 880 with separate software layers including a communication layer 882 coupled with the network, and an internal operations module 884.

In various embodiments, each of the different types of devices participating in the arrangement of FIGS. 4 and/or 8, namely, the user's computer, the master devices, and the ordinary devices has its own UPA module installed to enable it to communicate with the other devices in the arrangement. The UPA module on the user's computer, the user UPA module, is usually more comprehensive and complicated because it is used by the user to program and configure the other devices, receives reports and perform other functions, which generally necessitates more components and functionality. In various embodiments, the user UPA module may include a user interface layer 860 at the highest level (farthest from hardware layer) of the hierarchical/layered structure 858, that is used to present a user interface, such as login, data entry, data presentation, and various GUI elements customary in modern user interfaces appropriate for the available system functions. Those skilled in the art will appreciate that in a layered structure, having a similar structure to that of the ISO-OSI (International Standards Organization—Open System Interconnect) communication model, each layer is in communication only with the next adjacent layer on both sides, as applicable, and cannot directly communicate with other non-adjacent layers. The layers have predefined interfaces between them, so this structure allows minimal inter-layer dependency while also allowing to change a layer without affecting other layers as long as the interface between the layers is not changed. Other software abstractions exist in this structure that is known to those skilled in the art, such as data encapsulation and shielding each layer from the details and complexities of the other layers.

In various embodiments, at the next lower level of the software structure of UPA, a logic layer 862 is interfaced with layer 860 and may be used to perform the programming, rule composition, configuration and other substantive operations. The user may write/enter, download, or select from an existing list of options rules that are later downloaded to the master and/or ordinary devices for configuring or programming the devices. Using the functionality of this layer, the user may also enter or load a computer program from an external storage source, whether compiled or script, for later downloading of the executionable form of the program, for example, after compiling or translating to a machine language, to the devices to control their operations. The programs and rules may include event handlers, service routines, logic to handle the event handlers and services, programs that specify how to configure other devices, how to send reports back to the user computer, programs for controlling other master devices by a central or supervisory master device, and any other functions that the master device or ordinary devices may be programmed or configured to perform.

In various embodiments, at the next lower level of the software structure of UPA, a data communication layer 864 is interfaced with layer 862 and may be used to perform the data communications, including sending and receiving data packets, establishing a communication link, negotiating protocols and data rates, and other communication-related functions needed for data transmission. This layer is generally the interface between the UAP module on any device on which it is installed with other UAP modules installed on other devices. For example, the user may download a rule or a program to a master device. The data representing the rule are transmitted to the master device by the UAP communication layer 864 on the user computer to the UAP communication layer on the master device described below.

In various embodiments, the master device UPA module may include a layered software structure 870 having a communication layer 872 and an internal operations layer 874. The communication layer is similar to communication layer 864 for the same purposes, at least in part. It is used to communicate with layer 864 of the user UPA module and layer 882 of the ordinary device UPA module. The internal operations layer 874 is used to receive and load configuration data, programs, and rules send from the user computer that control the operation of the master device. This layer may store such rules/programs in the memory 868 for execution by the CPU/controller of master device 866. It may also handle other peripheral support functions, such as UPA software and rules updates, event handlers, service operations, configuring other ordinary devices or master devices, replicating its programs to other master devices, providing reports to the user computer, and any other functions the master device may have to perform.

In various embodiments, the ordinary device UPA module may include a layered software structure 880 having a communication layer 882 and an internal operations layer 884. The communication layer is similar to communication layer 864 for the same purposes, at least in part. It is used to communicate with layer 864 of the user UPA module and layer 872 of the master UPA module. The internal operations layer 884 may be used to receive and load configuration data, and for some devise programs, and rules send from the master device that control the operation of the ordinary device. This layer may store such rules/programs in the memory 878 for execution by CPU/controller of ordinary device 876, for some more advanced ordinary devices that have a processor or controller. It may also handle other peripheral support functions, such as accepting commands to send event notifications or perform services and return results, and any other functions the ordinary device may have to perform.

Those skilled in the art will appreciate that the Layers may be arranged differently or include more or fewer layers that divide up various functions without departing from the spirit of the present disclosures.

In various embodiments, the device configuration system and the UPA software and modules 858, 868, and 878 may be implemented by a hardware and/or software system using one or more software components executing on the illustrative computing device of FIG. 2, or simpler embedded versions of such computing devices. One or more functions may be performed by each software module recorded on a medium such as an optical disk, magnetic tape, volatile or non-volatile computer memory, and the like, or transmitted by various communication techniques using various network and/or communication protocols, as described above with respect to FIG. 1. For example, one or more separate software components may be used for each of the functions in the system such as various user interfaces for defining/specifying events, event handlers, services, actions, logical and relational expressions, and the like. Other modules may be used to load and execute various rules, commands, service routines, return results, manage local data stores, switch in and out of configuration and operational modes, and the like. Still other modules may be used to carry out communication functions such as authenticating, joining a network or subnet, sending and receiving messages and data between various ordinary and master devices and user computers, implement communication protocols, sending and receiving discovery packets, and the like. Those skilled in the art will appreciate that one function may be implemented using multiple software modules or several functions may be implemented using one software module. With further reference to FIG. 2, these software modules are generally loaded into the memory module 206 of the computing device for execution.

Those skilled in the art will appreciate that to communicate with a device coupled locally or remotely to a computer, such as a printer, a keyboard, a scanner, a network adapter, a mouse, industrial equipment, and other peripheral devices, a software driver installed on the computer is often needed. A driver is a software module that is a part of the operating system of the computer and is designed as a mid-layer module between the operating system of a computer and the device. Some software drivers may have multiple internal layers of their own. A common characteristic of a driver is that structurally it is placed between the operating system and the hardware and includes the knowledge of the internal functions of the device for which it is designed. The driver also knows, in relevant parts, how to communicate with the operating system through function calls and data structures. As such, drivers are usually supplied by the device manufacturer, or third party vendors, and is installed on the computer as a driver by the user. So, for example, a printer driver is provided by the manufacturer of the driver and knows how to communicate with the computer and the printer device. When an application, such as word processor, sends a print request to the printer, the driver takes the command and the data to be printed and formats it for transmission to the printer in a form that the printer can process. The driver also translates the local computer commands, such as print double-sided, to the printer in printer command format so the printer can understand and carry out the command from the computer. As such, each device that is connected to the computer needs to have its own device driver to be installed on the computer to work.

In contrast to the above, the UPA modules installed on the computer play the role of a universal driver if the devices have corresponding UPA modules, as described above. Hence, in the device configuration system described herein, the need for a special driver for each device is precluded and replaced by the functions provided by the UPA modules, which can interact and communicate with each other.

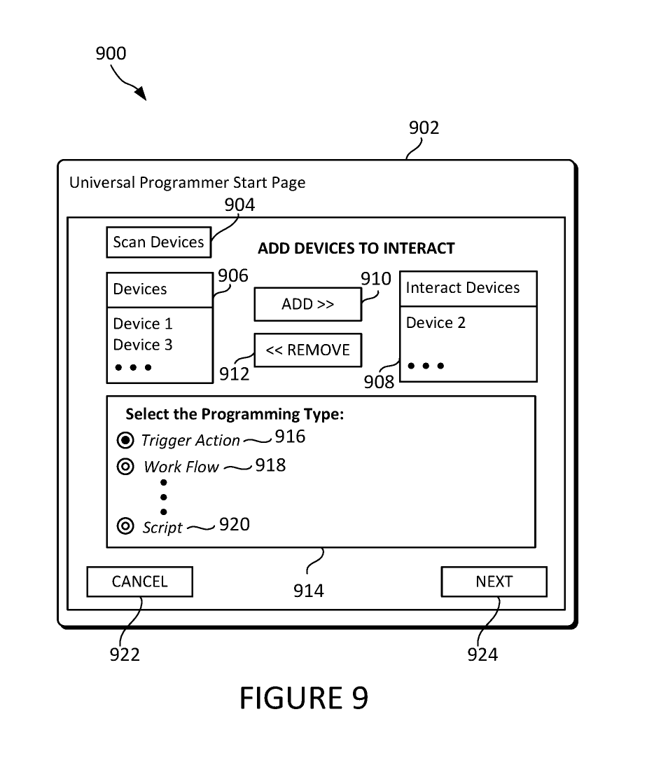

FIG. 9 shows an example UPA start page for finding devices in communication environments of FIGS. 3 and 4 and selecting programming types. In various embodiments, UPA Start page 900 includes start page window 902 having a Scan Devices button 904, devices list 906, Add button 910 for adding devices to device interaction list 908 and Remove button 912 for removing devices from the device interaction list, programming type selection section 914 having Trigger Action 916, Workflow 918, Script 920, and other programming types. A Cancel button 922 and Next button 924 may also be included.

In various embodiments, in operation, the user may go to the UPA start page to start the selection of ordinary and/or master devices to interact with and to choose programming method of the selected devices. Once at the Start page, the user may select one or more devices from a device list 906 previously discovered by a master device or the user's computer or a third party service called by the user UPA module or master device UPA module. In some embodiments, finding new devices may be accomplished by selecting the Scan Devices button 904, which may cause the use of a Discovery Request network packet to discover new devices on a subnet, among other similar practices. Those skilled in the art recognize that a Discover packet may be sent onto the network or local subnet by devices power up or coming online. A DHCP (Dynamic Host Configuration Protocol) server may capture the Discover packet and respond to it. Other similar protocols may be used to discover new devices on the network. The user may then use the Add and Remove buttons to create or change an in interactive devices list 908 that defines which ordinary devices the user wishes to interact with. Once the interactive device list is completed, the user may then choose a method of programming, such as the Trigger Action, 916 Workflow 918, Script 920, or others. The user may cancel this step by using the Cancel button or may move to the next UPA configuration screen.

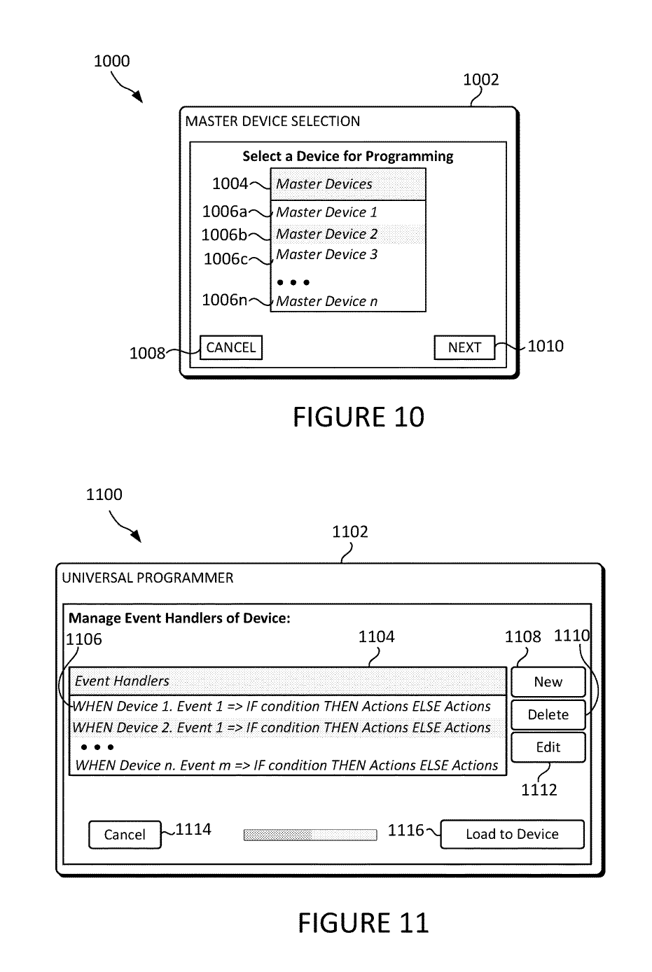

FIG. 10 shows an example UPA master device selection user interface. In various embodiments, UPA master device selection 1000 includes a master device selection page 1002 having a list of master devices 1004 including master devices 1006a, 1006b, 1006c, through 1006n, a Cancel button 1008 and a Next button 1010.

In various embodiments, the user may select a desired master device from the list 1004 and then select Next button 1008 to continue with configuring the selected master device. The Cancel button 1008 may be used to cancel this step. Other screens described below may be used subsequently to continue the programming and configuration of the selected master devices.

FIG. 11 shows an example UPA event handler management user interface. In various embodiments, Event Handler configuration 1100 includes an Event Handler Management page 1102, an Event Handler definition dialog box 1104 having multiple lines 1106, a New button 1108, a Delete button 1110, an Edit button 1112, a Cancel button 1114, and a Load button 1116.

In various embodiments, the Event Handler dialog box 1104 is used to define new event handlers or change existing ones. This dialog box is used to define the handler and the actions it takes, not the event itself. The event may be defined in another dialog box, as further described below with respect to FIG. 13. In some embodiments, an event associated with a selected device, such as “Device1.Event1” (specified in this example with the dot notation, which indicates a member of a set, here shown as Event1 belonging to set Device1), is used in a rule. The rule specifies that if this event occurs (or if a logical or relational condition expression evaluates to TRUE), then some action is launched in response, and if the event does not occur (the expression evaluates to FALSE; the ELSE condition) then another action may be launched. For example, if exceeding a temperature threshold event is detected in a device, then the action launched may be to turn on a cooling device, otherwise, no action may be taken. Once the rules defining the actions to be taken in the case of the detection of a particular event are defined, they may be loaded onto the selected device using the Load button 1116. The Cancel button may be used to cancel this step of the configuration, for example, to go back and select an alternate device or to delay configuration for later.

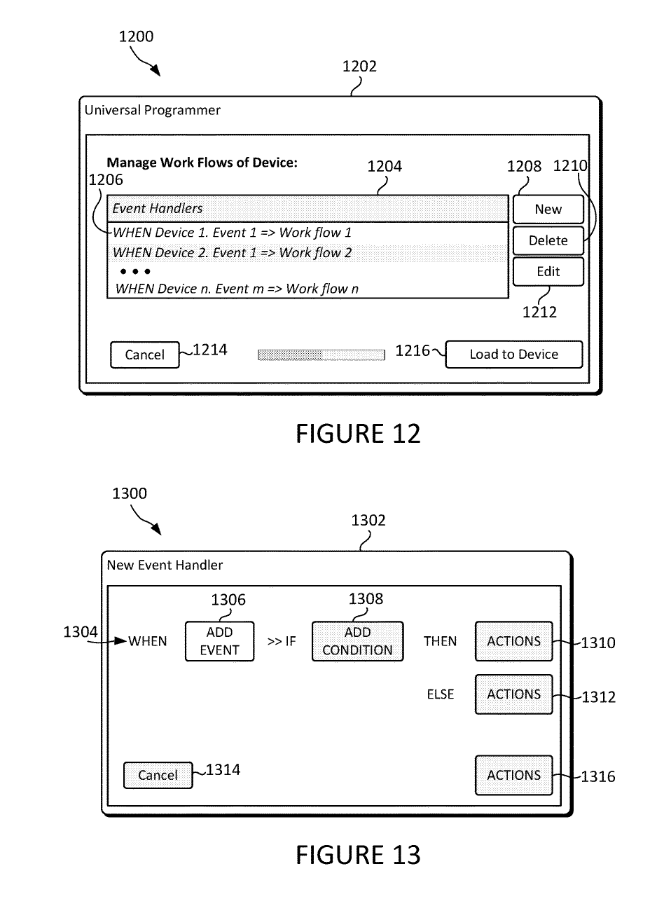

FIG. 12 shows an example UPA workflow definition and management user interface. In various embodiments, Workflow Management 1200 includes a Workflow Management page 1202, a Workflow Management dialog box 1204 having multiple lines 1206, one for each event, a New button 1208, a Delete button 1210, an Edit button 1212, a Cancel button 1214, and a Load button 1216.

In various embodiments, the Workflow Management dialog box 1204 is used to assign a workflow to an event or change existing ones. This dialog box is used to define the assignment of existing workflows to particular events, such when the particular event occurs, the assigned workflow is executed. Those skilled in the art will appreciate that a workflow is a sequence of related actions executed in a particular predefined sequence, sometimes based on predefined conditions, to perform a particular task or carry out a predefined process. For example, a workflow in a device may consist of running a series of related tests to test the reliability of a communication channel. Such workflow may include creating a test packet, sending it to a predefined receiver and receiving an acknowledgement. The event may be defined by the manufacturer of the device based on the physical capabilities and features of the device. For example, if the device is a light sensor, then the events it may have or support may be limited to detecting one or more light level thresholds. In some embodiments, an event associated with a selected device, such as “Device3.Event5” (specified in this example with the dot notation, which indicates a member of a set, here shown as Event5 belonging to set Device2), is used in an assignment. The assignment specifies that if this event occurs, then some workflow is launched in response by the associated event handler. For example, if exceeding a temperature threshold event is detected in a device, then the workflow launched may be to validate the temperature reading and turn on a cooling device. Once the assignments of workflows to various events are completed, they may be loaded onto the selected device using the Load button 1216. The Cancel button may be used to cancel this step of the configuration, for example, to go back and select an alternate device or to delay configuration for later.

FIG. 13 shows an example UPA event handler addition and definition user interface. In various embodiments, Event Handler definition user interface 1300 includes a New Event Handler dialog box or window 1402, an event handler definition or expression line 1304, an Add Event button 1306, an Add Condition button 1308, an Actions button 1310, a default Action button 1312, a Cancel button 1314, and a Next button 1316.

In various embodiments, a new event handler (not event) may be defined in this window by selecting the Add Event button 1306 to specify which event triggers the activation or execution of the new event handler. The Add Condition button is used to define one or more predetermined conditions that if true when the specified event occurs, then a particular action is carried out by the new event handler. If such conditions are not true at the time the event occurs, then an alternative or default action may be performed. For example, the new event handler may be associated with an event that indicates dimming lighting conditions outside. This event handler may check the time of day and calendar as a condition for this event, and if the time is past a certain threshold or point in the day, like 6:00 PM, the event handler may lock the doors and turn on the lights. If the time is not past the certain point, then it may only turn on the lights but leave the doors unlocked as a default action. The Action buttons 1310 and 1312 may be used to specify what action the event handler may take when the event occurs and the conditions hold or do not hold, respectively. The actions may be specified by picking routines or options from a drop-down list, or otherwise specified by associating a hardware action (such as activating a circuit or connecting two points via an electrical relay, and the like) or a software action (executing a subroutine for performing some task) with the event handler.

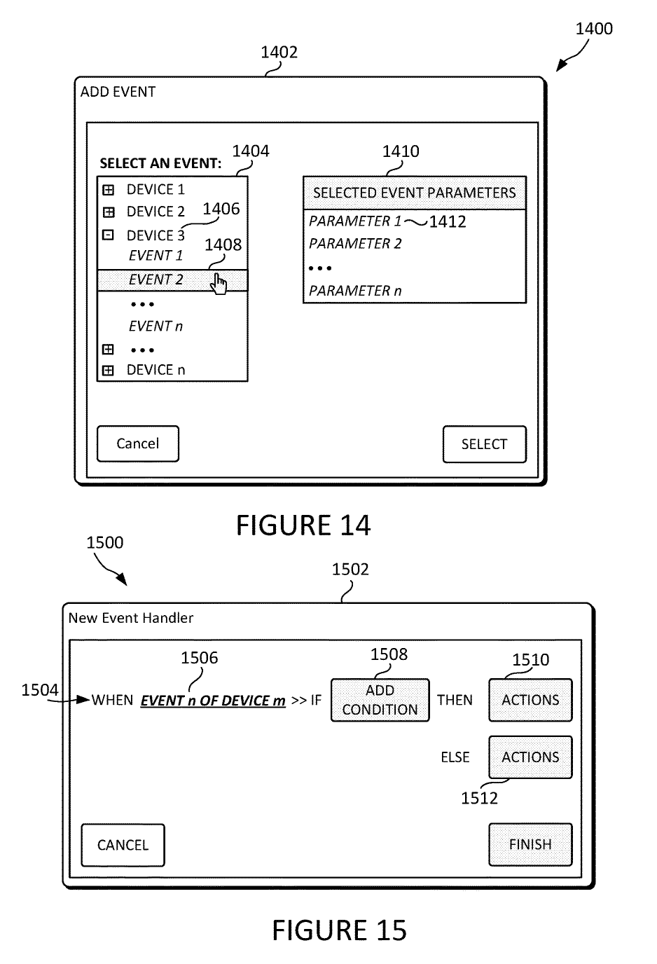

FIG. 14 shows an example UPA device event selection and parameter identification and management user interface. In various embodiments, event parameter selection user interface 1400 includes an event dialog box 1402 having a list of devices and events 1504 including devices 1406 and corresponding events 1408 belonging to those devices, and selected parameters list 1410 having parameters 1412 belonging to selected events.

In various embodiments, events and respective parameters can be selected by a user from an event selection user interface. The event parameters are similar to function arguments in a mathematical function in which the parameters provide specific information for specification, identification, or use of the event. For example, and event “Event1(Parameter1, Parameter2)” may be “Light-Level-Fault(Light-Threshold1, Light-Threshold2)”. In this example, the Light-Level-Fault event is triggered if a measured light level is outside the range of “Light-Threshold1 minus Light-Threshold2”, specified by the two parameters, which specify two light level thresholds. These parameters allow the event to determine when to be triggered. Different values of these parameters can trigger this event differently. Using the dot notation, an event parameter may be specified as “Device-X.Event-Y.Parameter-Z” for device X, event Y within device X, and parameter Z within event Y.

FIG. 15 shows an example UPA new event handler definition based on events of a particular selected device. In various embodiments, new Event Handler definition user interface 1500 includes a New Event Handler dialog box or window 1502, an event handler definition or expression line 1504, an event specification 1506, an Add Condition button 1508, an Actions button 1510, a default Action button 1512, and a Cancel button and a Finish button.

In various embodiments, a new event handler (not event) may be defined in this window corresponding with the event identifier 1506 to specify which event triggers the activation or execution of the new event handler. The Add Condition button is used to define one or more predetermined conditions that if true when the specified event occurs, then a particular action is carried out by the new event handler. If such conditions are not true at the time the event occurs, then an alternative or default action may be performed. For example, the new event handler may be associated with an event that indicates temperature rising above a predefined or preset threshold in a space such as a room. This event handler may check a condition based on the state of a window, being open or closed, and if the window is closed, the event handler may turn ON the air conditioner to cool down the space. If the window is open, then as a default action, the event handler may only blink a light, beep, issue a message on a screen, send a message to a cellphone, or give other indication that the window needs to be closed before air condition is turned ON. The Action buttons 1510 and 1512 may be used to specify what action the event handler may take when the event occurs and the conditions hold or do not hold, respectively. The actions may be specified by picking routines or options from a drop-down list, or otherwise specified by associating a hardware action (such as activating a circuit or connecting two points via an electrical relay, and the like) or a software action (executing a subroutine for performing some task) with the event handler.

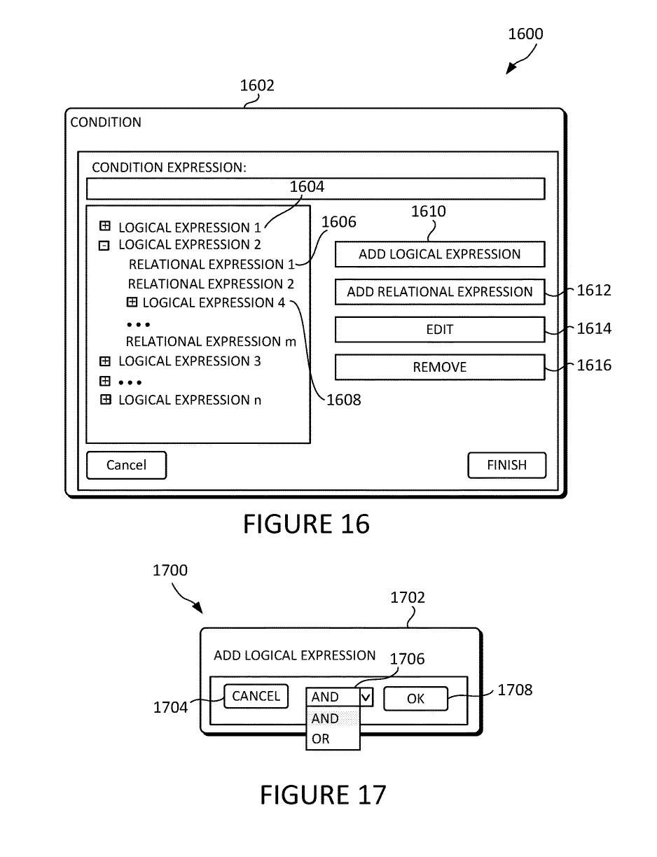

FIG. 16 shows an example UPA conditional expression definition and management user interface. In various embodiments, conditional expression management user interface 1600 includes a conditional expression management dialog window 1602, logical expressions 1604, relational expressions 1606, Add Logical Expression button 1610, Add Relational Expression 1612, an Edit button 1614, and remove button 1616. Cancel and Finish or Next buttons may also be included in the user interface.

In various embodiments, many of the events, actions, event handlers, and other device related control mechanism may involve conditional expressions that may be defined in various stages of the configuration to specify how each device should behave under certain conditions, as further described herein. A condition may be expressed using a logical expression or a relational expression. A logical expression may be a combinational logic expression in which various logical, Boolean, or binary variables (conventionally shown in capital letters like A, B, X, Y, etc., which take on only one of two values such as {True, False} or {1, 0}) are combined with logical connectives or operators such as AND, OR, NOT, NAND, XOR, and the like. A logical expression is used to expressed certain conditions that may exist, based on which some action may be taken. For example, if A is a Boolean or binary or logical variable representing whether a door is open, and B is a variable representing that a temperature threshold is exceeded, then the expression “A AND NOT B” means “If temperature is hotter than a set limit and door is not open”. The user may select button Add Logical Expression 1610 to start the process of adding one or more logical expressions to define actionable conditions, as further described below with respect to FIG. 17.

A relational expression defines a relative and/or comparative relationship between two quantities and the connectives or operators of which are conventionally represented by the following symbols: =(equal), /=(not equal), >(greater than), <(less than), >=(greater than or equal), <=(less than or equal). For example, if A is a measured temperature and B is a preset threshold, then the expression “if A>B” means “if the measured temperature is greater than the preset threshold”. Such an expression alone or in combination with one or more other logical and/or relational expressions may be used to define a condition that when satisfied, some predefine action is taken.

FIG. 17 shows an example UPA logical expression definition user interface. In various embodiments, a Logical Expression definition user interface 1700 may include a Cancel button 1704, a set of logical connectives or operators 1706, and an OK button.

In various embodiments, the user may use the list or set of logical operators 1706 to select a logical operator and apply it to an expression being defined. Those skilled in the art will appreciate that the user interface windows described herein may be used in conjunction with other user interface windows or individually depending on the overall design of the user interface. For example, if the user is defining a new event handler (for example, FIG. 15), the definition of the condition using the button 1508 may launch the appropriate user interface of FIG. 17 to select the logical operator to be used in the expression 1504 and then revert to the interface 1500 afterwards.

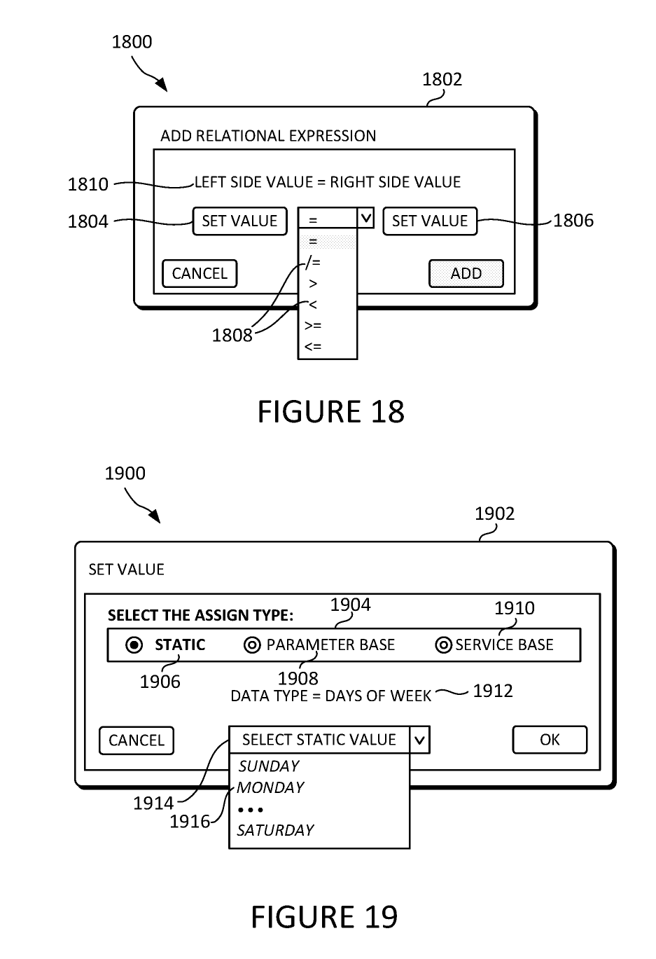

FIG. 18 shows an example UPA relational expression definition user interfaced. In various embodiments, a Relational Expression definition user interface 1800 may include a Left Value button 1804, a Right Value button 1806, and a set of relational connectives or operators 1808.

In various embodiments, the user may use the list or set of relational operators 1808 to select a relational operator and apply it to an expression being defined. The relational operators include: =(equal), /=(not equal), >(greater than), <(less than), >=(greater than or equal), <=(less than or equal). These operators are generally binary and have two sides or variables for comparison (for example, a Left Value and a Right Value). The relational comparison can be performed if the types of these variables are the same or compatible. If the types are not compatible or comparable then they cannot be compared. For example, if one variable has a type of “time” and the other has a type of “temperature”, then they cannot be compared, because saying this time is greater than this temperature has no meaning. Those skilled in the art will appreciate that the user interface windows described herein may be used in conjunction with other user interface windows or individually depending on the overall design of the user interface. For example, if the user is defining a new event handler (for example, FIG. 15), the definition of the condition using the button 1808 may launch the appropriate user interface of FIG. 18 to select the relational operator to be used in the expression 1504 and then revert to the interface 1800 afterwards.

FIG. 19 shows an example UPA static value type selection user interface. In various embodiments, Value Setting user interface 1900 includes a Value Setting dialog window 1902 a value type selection list 1904, a selected Static type value 1906, a Parameter base type 1908, and a Service base type 1910, a selected data type 1912, and a static value list 1914 having various values 1916.

In various embodiments, the Left Value 1804 and Right Value 1806 of FIG. 18, may be set using the Value Setting interface. These left and right values or variables of a relational expression each have a type and a value. Generally, the type of the relational variable is set first before the value is assigned. The types may generally be Static, which has definite and fixed values, like days of the week, parameter based defined by the device events or services, and service based defined by the services offered by the device. Depending on which one of these types are selected, a variation of this interface may be presented to set the values. For example, if a data type for a relational variable is set to [Static]−[Days of Week], then the value assigned may be picked from the list 2014 as Monday.

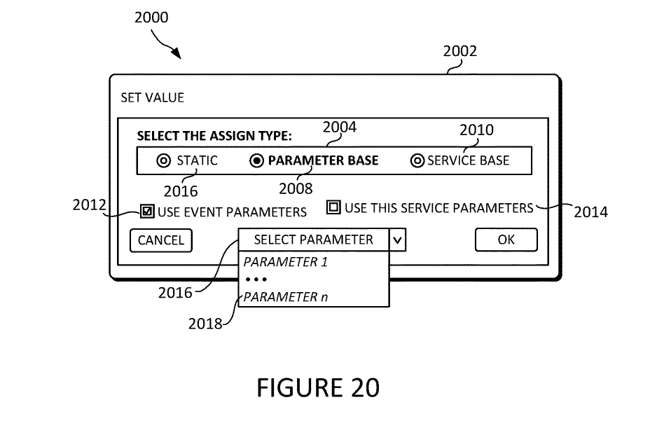

FIG. 20 shows an example UPA parameter-based value type selection user interface. In various embodiments, Value Setting user interface 2000 may be derived from the interface of FIG. 19 by selecting the parameter-based type and includes a Value Setting dialog window 2002 a value type selection list 2004, a Static type value 2006, a selected Parameter base type 2008, and a Service base type 2010, a selected event source checkbox 2012 indicating source of the parameter-based value, a non-selected service source checkbox 2014 indicating service parameters as the source, and a selection value list 2016 having various values 2016.

In various embodiments, the when the parameter base 2008 is selected, the source of the parameter may also be specified as either events 2012 or services 2014, since both may have parameters with pre-designated types. If the event parameters 2012 are selected, then dropdown list 2016 of event parameters 2018 may be used to select a type to be used for the value in the relational expression.

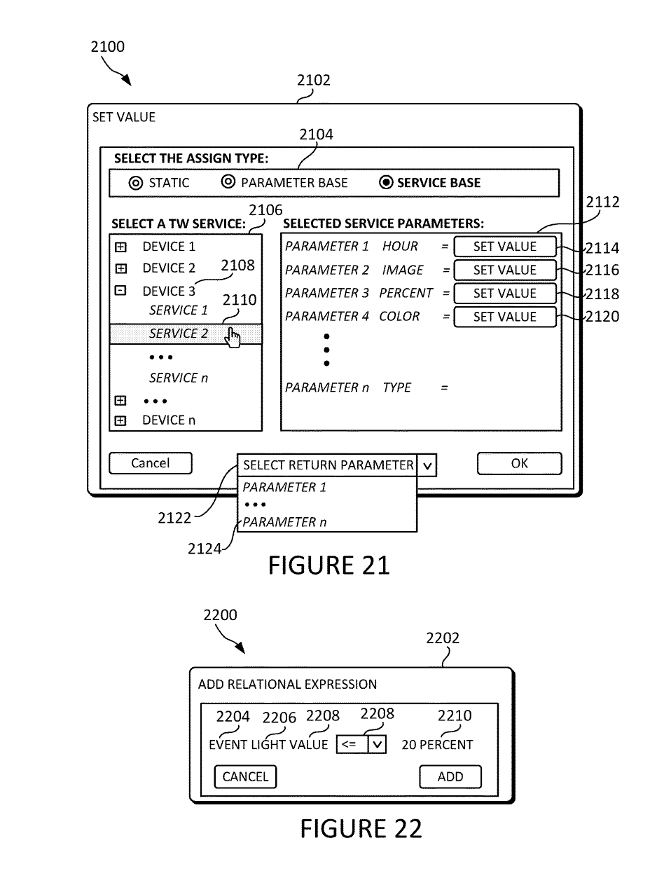

FIG. 21 shows an example UPA service-based value type selection user interface. In various embodiments, Value Setting user interface 2000 may be derived from the interface of FIG. 19 by selecting the service-based type and includes a Value Setting dialog window 2102, a value type selection list 2104, a Static type value, a selected Parameter base type, and a selected Service base type. A device list 2106 lists the devices 2108 from which services 2110 may be selected. It further includes Selected Service Parameters list 2112 with predesignated types such as HOUR, IMAGE, PERCENT, COLOR, and the like, each having a button 2114, 2116, 2118, 2120, respectively for setting a value or quantity for the corresponding parameter. The interface further includes a Return Parameter list 2122 to select a return parameter 2124 that may be returned by the Service call.

In various embodiments, when the parameter base 2008 is selected, the source of the parameter may also be specified as either events 2012 or services 2014, since both may have parameters with pre-designated types. If the service base is selected, then a device is selected by the user from the device list 2106, and a particular service 2110 is further selected. The selected service 2110 may be associated with a number of service parameters 2112, each having a predetermined type as defined by the manufacturer of the device. Specific values may be set using the corresponding value setting buttons 2114-2120, as described with respect to FIGS. 19-21 above, to serve as the value in the relational expression. Some services may also return a value to the calling entity. The parameter returned may be selected by the user as one or more parameters 2124 from the Return Parameter list 2122. For example, if a device measure the temperature in a space, then calling a temperature reporting service may return the measured temperature to the calling entity, such as a service in a master device or a software module on the user UAP.

FIG. 22 shows an example UPA event parameter-based relational expression definition user interface. In various embodiments, the Relational Expression definition user interface 2200 may include an event 2204 and a parameter of the event 2206, a relational operator selection list 2208, a Right Value 2210, and Cancel and Add buttons.

In various embodiments, the user may use the list or set of relational operators 2208 to select a relational operator and apply it to an expression being defined. As noted before, the relational operators include: =(equal), /=(not equal), >(greater than), <(less than), >=(greater than or equal), <=(less than or equal). The two variables or quantities subject to the relational operators may be defined as an event parameter 2206, a service parameter, or other parameter to be compared with the other relational parameter 2210, which may be a constant, or another event or service parameter. For example, a light value may be a parameter of an event, which may be compared to a percentage of a total brightness to take some action, such as turning OFF the light or increasing or decreasing its brightness.

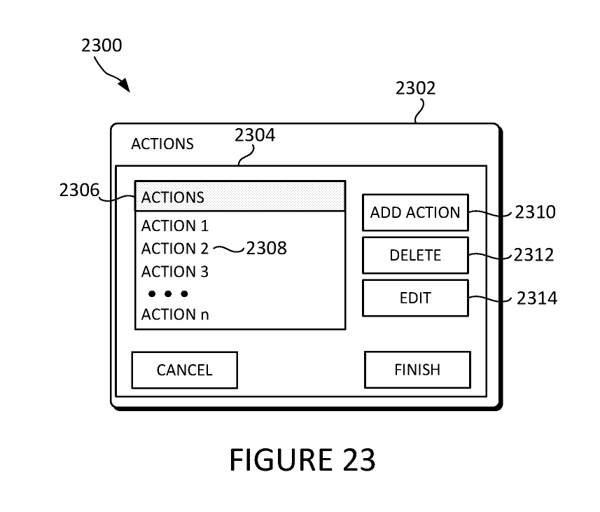

FIG. 23 shows an example UPA action definition user interface. In various embodiments, Action Definition user interface 2300 includes Action Definition dialog box 2302, Action management window 2304, existing action list 2306 listing specific actions 2308, Add Action button 2310, Delete Action button 2312, Edit Action button 2314, and Cancel and Finish buttons.

Those skilled in the art will appreciate that the user interface windows described herein may be used in conjunction with other user interface windows or individually depending on the overall design of the user interface. For example, if the user is defining a new event handler (for example, FIG. 15), the definition of the actions to be taken using the button 1510 may launch the appropriate user interface of FIG. 23 to select and/or add the action to be used in the expression 1504 and then revert to the interface 1500 afterwards. In various embodiments, an action 2308 may be selected from the actions list 2306 to be employed in an event handler. Using buttons 2310-2314, the user may further add, delete, or edit actions, respectively. The actions may be in the form of services that are built into the devices or master devices or may be programmed actions downloaded by the user onto the master devices, such as providing reports, or calling other services in the same or other devices. For example, a service provided by a master device or ordinary device may include sending a message to another device to start a process, provide a report of current device status, authenticate a communication device for sending or receiving messages on a subnet, and the any other services or functions various devices may perform on command.

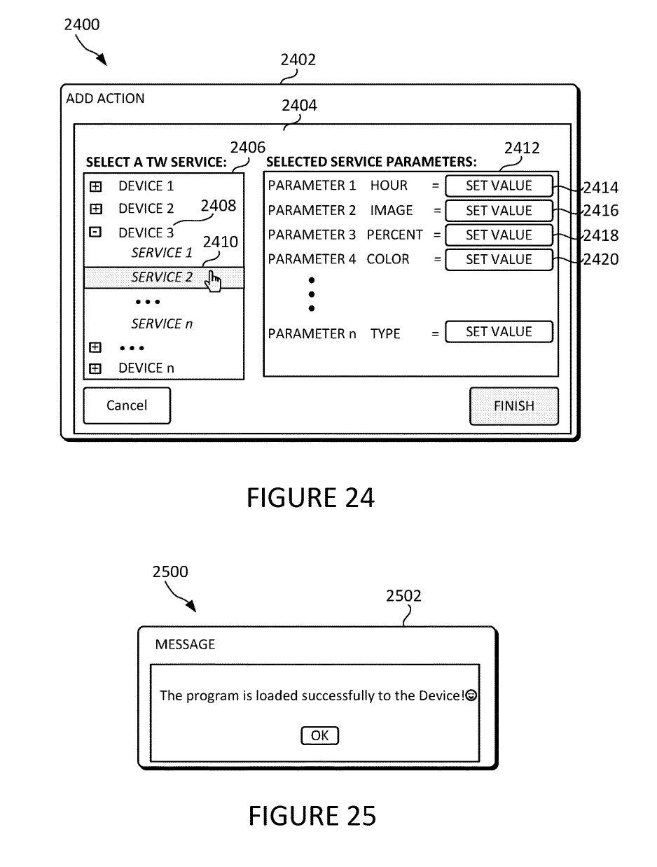

FIG. 24 shows an example UPA service-based action definition user interface. In various embodiments, Add Action user interface 2400 includes a Add Action dialog window 2402, a Action addition management window 2404, a device list 2406 listing devices 2408 from which services 2410 may be selected as actions to be used. It further includes Selected Service Parameters list 2412 with predesignated types such as HOUR, IMAGE, PERCENT, COLOR, and the like, each having a button 2414, 2416, 2418, 2420, respectively for setting a value or quantity for the corresponding parameter. The interface may further include a Return Parameter list (not shown) to select a return parameter that may be returned by the Service call.

In various embodiments, an action to be taken by an event handler may be in the form of a service/function call by a requester, such as a master device. To specify an action for use in an event handler, in the form of a service offered by a device, first a device is selected by the user from the device list 2406, and then a particular service 2410 is further selected. The selected service 2110 may be associated with a number of service parameters 2412, each having a predetermined type as defined by the manufacturer of the device. Specific values may be set using the corresponding value setting buttons 2114-2120 to serve as the value in the relational expression or to be used for another purpose such as testing. Some services may also return a value to the calling entity. The parameter returned may be selected by the user as one or more parameters from the Parameter list. For example, if a device measures the temperature in a space, then calling a temperature reporting service may return the measured temperature to the calling entity, such as a service in a master device or a software module on the user UAP.

FIG. 25 shows an example UPA programming conclusion confirmation user interface. In various embodiments, a message interface 2500 may include a message dialog box 2502 to provide a message to the user of the UPA. For example, once the configuration of devices, events, event handlers, and the like are completed, the message interface may be used to notify the user of the completion.

It will be understood that each step of the processes described above, and combinations of steps, may be implemented by computer program instructions. These program instructions may be provided to a processor to produce a machine, such that the instructions, which execute on the processor, enable implementing the actions specified. The computer program instructions may be executed by a processor to cause a series of operational steps to be performed by the processor to produce a computer implemented process such that the instructions, which execute on the processor to provide steps for implementing the actions. The computer program instructions may also cause at least some of the operational steps to be performed in parallel. Moreover, some of the steps may also be performed across more than one processor, such as might arise in a multi-processor computer system. In addition, one or more steps or combinations of steps described may also be performed concurrently with other steps or combinations of steps, or even in a different sequence than described without departing from the scope or spirit of the disclosure.

Accordingly, steps of processes or methods described support combinations of techniques for performing the specified actions, combinations of steps for performing the specified actions and program instruction for performing the specified actions. It will also be understood that each step, and combinations of steps described, can be implemented by special purpose hardware based systems which perform the specified actions or steps, or combinations of special purpose hardware and computer instructions.

It will be further understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” It is further understood that any phrase of the form “A/B” shall mean any one of “A”, “B”, “A or B”, or “A and B”. This construct includes the phrase “and/or” itself.

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A device configuration system comprising:
a user computing device having a Universal Programming Application (UPA) stored thereon, the user computing device coupled with a computer network;
a master device coupled with the computer network and having a master device UPA stored thereon to communicate with the user computing device UPA; and
an ordinary device coupled with the computer network and having an ordinary device UPA stored thereon to communicate with the user computing device UPA and the master device UPA.

2. The system of claim 1, further comprising a user interface presented by the user computing device UPA to the user of the user computing device.

3. The system of claim 1, wherein the master device includes a memory module to store a downloaded program and a processor to execute the downloaded program.

4. The system of claim 1, wherein the UPA has a layered structure.

5. The system of claim 1, wherein the user computing device UPA has a layered structure including a user interface layer, a programming layer, and a communication layer.

6. The system of claim 1, wherein the master device provides an event and a service.

7. The system of claim 1, wherein the master device provides an event and a service, each of the event and the service having associated parameters.

8. The system of claim 1, wherein the ordinary device provides an event having associated parameters.

9. An inter-device communication system comprising:
a master device coupled with a computer network having a master device Universal Programming Application (UPA) stored thereon to configure an ordinary device; and
an ordinary device coupled with the computer network having an ordinary device UPA stored thereon to communicate with the master device UPA.

10. The system of claim 9, further comprising a user computer having a user computer UPA stored thereon to communicate with the master device UPA and the ordinary device UPA.

11. The system of claim 9, wherein the master device UPA and the ordinary device UPA have a layered structure including a communication layer and an internal operations layer.

12. The system of claim 9, wherein master device includes a memory module and a microprocessor to execute programs.

13. The system of claim 9, wherein the master device and the ordinary device provide events and services that are configurable via their respective UPA interfaces.

14. The system of claim 9, wherein the master device includes event handlers to take predefined actions in response to events reported by the ordinary device.

15. A method of networked device configuration, the method comprising:
downloading a program to a master device, having a master device Universal Programming Application (UPA) stored thereon, from a user computer having a user computer UPA stored thereon in communication with the master device UPA;
programming the master device using the downloaded program; and
configuring an ordinary device, having an ordinary device UPA stored thereon, by the master device.

16. The method of claim 15, further comprising calling a service provided by the master device by another master device or by the user computer to perform a task.

17. The method of claim 15, further comprising defining an event handler in a master device to react in response to events reported by the ordinary device.

18. The method of claim 15, further comprising selecting a service offered by the master device to be used as an action to be taken by an event handler associated with an event of the ordinary device.

19. The method of claim 15, wherein a service offered by the master device returns a value.

20. The method of claim 15, wherein the ordinary device provides events associated with parameters.
